(19) United States
(12) Patent Application Publication
(10) Pub. No.: US 2010/0231843 A1
(43) Pub. Date: Sep. 16, 2010

(54) LIQUID CRYSTAL DISPLAY ELEMENT, METHOD OF MANUFACTURING THE ELEMENT, AND ELECTRONIC PAPER AND ELECTRONIC TERMINAL APPARATUS UTILIZING THE ELEMENT

(75) Inventor: Shinji Tadaki, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/785,912

(22) Filed: May 24, 2010

Related U.S. Application Data
(63) Continuation of application No. PCT/JP2007/074665, filed on Dec. 21, 2007.

(51) Int. Cl. G02F 1/1343; H01J 9/24

(52) U.S. Cl. 349/156; 445/24

(57) ABSTRACT

The invention relates to a display element displaying images utilizing a cholesteric liquid crystal. The display element has improved contrast and can therefore display high quality images. The display element includes a pair of substrates, a liquid crystal enclosed between the pair of substrates, first electrodes formed on either of the pair of substrates, second electrodes formed on the other of the pair of substrates, a pixel region defined by disposing the substrates such that the first electrodes and the second electrodes face each other in an intersecting relationship, a wall structure formed between the pair of substrates and outside the pixel region so as to surround the pixel region, an opening provided in a part of the wall structure to allow the liquid crystal to flow, and a reflectance reducing portion formed at the opening to reduce the reflectance of the liquid crystal at the opening.

This application is a continuation of International Application No. PCT/JP2007/074665, filed Dec. 21, 2007.

### BACKGROUND OF THE INVENTION

1. Field of the Invention

The present invention relates to a liquid crystal display element displaying images utilizing a cholesteric liquid crystal layer, a method of manufacturing the element, and electronic paper and an electronic terminal apparatus utilizing the element.

2. Description of the Related Art

Reflective liquid crystal display devices utilizing liquid crystal compositions forming a cholesteric phase (referred to as “cholesteric liquid crystals) have memory display characteristics which allow an image to be semi-permanently displayed even when no electric power is supplied (such devices will be hereinafter referred to as “cholesteric liquid crystal display element”). Since cholesteric liquid crystal display elements are therefore required to be driven only when a display rewrite is performed, the power consumption, thickness, and weight of such elements can be made smaller than those of liquid crystal display elements according to the related art. Further, cholesteric liquid crystal display elements are characterized by their vivid display capability, high contrast, and high resolution. Researches are being carried out toward practical applications of such elements to take advantage of their characteristics as thus described. Cholesteric liquid crystal display elements are used with satisfactory results in display sections of electronic paper, electronic books, and display sections of electronic terminal apparatus such as portable apparatus, e.g., mobile terminal apparatus and IC cards.

A cholesteric liquid crystal display element includes a pair of substrate between which a cholesteric liquid crystal is enclosed. The substrates may be transparent substrates such as glass substrates or resin substrates. Pixels are formed by electrodes provided on the substrates and the cholesteric liquid crystal sandwiched between the electrodes. Columnar spacers or wall structures may be disposed between pixels adjacent to each other to keep a predetermined interval (cell gap) between the pair of substrates.

The reflectance of the cholesteric liquid crystal can be controlled by applying a liquid crystal driving voltage to pixel electrode portions where electrodes overlap each other in a face-to-face relationship. However, it is difficult to control the reflectance of the cholesteric liquid crystal in regions out of the pixel electrode portions, i.e., regions between pixels adjacent to each other where wall structures or the like are provided because no electrode for applying the liquid crystal driving voltage is provided in those regions. Wall structures may be formed between adjoining pixel electrodes, which makes it possible to shield the gaps between the adjoining electrodes where the cholesteric liquid crystal is uncontrolled while keeping the aperture ratio of the pixels unchanged. However, openings must be formed in parts of the wall structures to allow the liquid crystal to be injected into the liquid crystal cells, and no shield can be provided at the openings.

In the regions of the openings, the cholesteric liquid crystal is aligned in a reflective state having strong directivity which appears when the liquid crystal flows. That is, the liquid crystal in those regions is always kept in a planar state or a state of high reflectance, in general. For this reason, the regions of the openings can reduce contrast when black is displayed in a focal conic phase in which the liquid crystal has a low reflectance.

Patent Document 1: JP-A-2005-189662

Patent Document 2: U.S. Pat. No. 3,581,925

### SUMMARY OF THE INVENTION

It is an object of the invention to provide a display element which can display a high quality image with high contrast, a method of manufacturing the element, and electronic paper and an electronic terminal apparatus utilizing the element.

The above-described object is achieved by a display element including a pair of substrates, a liquid crystal enclosed between the pair of substrates, first electrodes formed on either of the pair of substrates, second electrodes formed on the other of the pair of substrates, a pixel region defined by disposing the substrates such that the first electrodes and the second electrodes face each other in an intersecting relationship, a wall structure formed between the pair of substrates and outside the pixel region so as to surround the pixel region, an opening provided in a part of the wall structure to allow the liquid crystal to flow, and a reflectance reducing portion formed at the opening to reduce the reflectance of the liquid crystal at the opening.

The above-described object is achieved by electronic paper for displaying an image, including a display element according to the above invention.

The above-described object is achieved by electronic terminal apparatus including a display element according to the above invention.

The above-described object is achieved by a method of manufacturing a display element having a liquid crystal enclosed between a pair of substrates, including the steps of forming first electrodes formed on either of the pair of substrates, forming second electrodes formed on the other of the pair of substrates, forming a pixel region by disposing the substrates such that the first electrodes and the second electrodes face each other in an intersecting relationship to define the pixel region, forming a wall structure between the pair of substrates and outside the pixel region so as to surround the pixel region, forming an opening in a part of the wall structure to allow the liquid crystal to flow, and forming a reflectance reducing portion at the opening to reduce the reflectance of the liquid crystal at the opening.

The invention makes it possible to display a high quality image with high contrast.

### BRIEF DESCRIPTION OF THE DRAWINGS

FIG. 1 is an exploded perspective view of a liquid crystal display element according to an embodiment of the invention schematically showing a configuration of the element;

FIG. 2 is a view of the liquid crystal display element according to the embodiment of the invention taken in the normal direction of substrate surfaces;

FIG. 3 is a sectional view of the liquid crystal display element according to the embodiment of the invention taken along the line A-A in FIG. 2;

FIG. 4 is a view of a liquid crystal display element according to the related art taken in the normal direction of substrate surfaces;

FIG. 5 is a sectional view of the liquid crystal display element according to the related art taken along the line A-A in FIG. 4;

FIG. 6 is a graph for explaining the liquid crystal display element according to the embodiment of the invention, the graph showing a relationship between cell gaps and reflectances of a cholesteric liquid crystal;

FIGS. 7A to 7F are sectional views of the liquid crystal display element according to the embodiment of the invention schematically showing steps for manufacturing the element;

FIGS. 8A to 8C are sectional views of the liquid crystal display element according to the embodiment of the invention schematically showing steps for manufacturing the element;

FIGS. 9A and 9B are illustrations showing major parts of a photo-mask used to form a wall structure of the liquid crystal display element according to the embodiment of the invention;

FIG. 10 is a sectional view of a liquid crystal display element according to a first modification of the embodiment of the invention showing an opening of the element;

FIG. 11 is an illustration showing major parts of a photo-mask used to form a wall structure of the liquid crystal display element according to the first modification of the embodiment of the invention;

FIG. 12 is a sectional view of a liquid crystal display element according to a second modification of the embodiment of the invention showing an opening of the element;

FIG. 13 is an illustration showing major parts of a photo-mask used to form a wall structure of the liquid crystal display element according to the second modification of the embodiment of the invention;

FIG. 14 is a view of a liquid crystal display element according to a third modification of the embodiment of the invention taken in the normal direction of substrate surfaces;

FIG. 15 is an illustration schematically showing a sectional configuration of a liquid crystal display element capable of full-color display provided stacking a plurality of liquid crystal display elements according to the embodiment of the invention; and

FIGS. 16A to 16C are illustrations showing specific examples of electronic paper having a liquid crystal display element according to the embodiment of the invention.

### DETAILED DESCRIPTION OF THE INVENTION

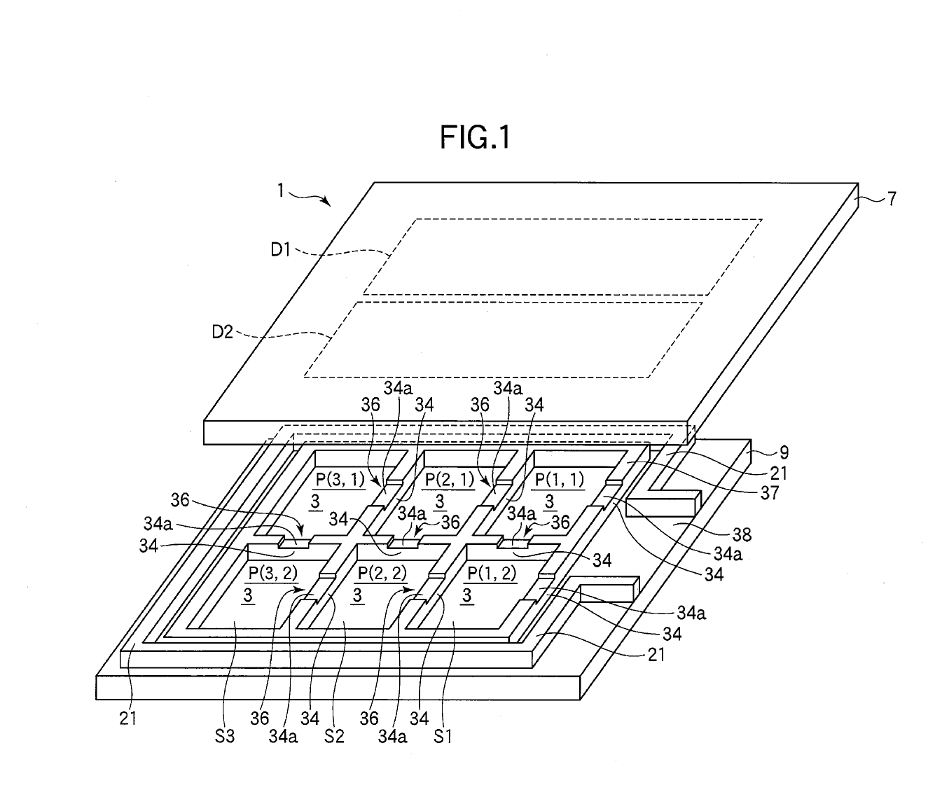

Display elements, methods of manufacturing the elements, and electronic paper and electronic terminal apparatus utilizing the elements in several modes for carrying out the invention will now be described with reference to FIGS. 1 to 16C. First, a display element in a mode for carrying out the invention (hereinafter referred to as “embodiment”) will be described with reference to FIGS. 1 to 6. FIG. 1 is an exploded perspective view of a liquid crystal display element 1 according to the present embodiment schematically showing a configuration of the same. The liquid crystal display element 1 includes a top substrate 7 and a bottom substrate 9 (a pair of substrates) disposed opposite to each other with a predetermined cell gap left between them. For easier understanding, the top substrate 7 is shifted upward and diagonally in the illustration of FIG. 1 from the position of the substrate in the actual positional relationship with the bottom substrate 9. For example, film substrates (plastic substrates) made of polycarbonate (PC) or polyethylene terephthalate (PET) or glass substrates are used as the top substrate 7 and the bottom substrate 9. A cholesteric liquid crystal 3 having memory characteristics is enclosed between the top substrate 7 and the bottom substrate 9.

The top substrate 7 has a plurality of data electrodes Dj (j represents natural numbers, and j=1 and 2 in FIG. 1) extending parallel to each other in the form of stripes, formed on a surface thereof at the interface between the liquid crystal 3 and itself. The data electrodes Dj are connected to a data electrode driving circuit which is not shown.

The bottom substrate 9 has a plurality of scan electrodes Si (i represents natural numbers, and i=1, 2, and 3 in FIG. 1) extending parallel to each other in the form of stripes, formed on a surface thereof at the interface between the liquid crystal 3 and itself. The scan electrodes Si are connected to a scan electrode driving circuit which is not shown.

The scan electrodes Si and the data electrodes Dj substantially orthogonally intersect each other when viewed in the normal direction of surfaces of the substrates 7 and 9. The intersections constitute pixel regions P(i,j). FIG. 1 shows six pixel regions P(1,1) to P(3,2) disposed in the form of a matrix having three rows and two columns by way of example. The pixel regions P(i,j) are driven by the data electrode driving circuit and scan electrode driving circuit which are not shown in a passive mode.

A wall structure 37 is provided around the pixel regions P so as to surround the pixel regions P. The wall structure 37 is formed outside the pixel regions P. The pixel regions P have a square shape having four sides when viewed in the normal direction of the substrate surface. Therefore, the wall structure 37 extends in the form of a square around each pixel region P when viewed in the same direction. When the substrate surface is viewed as a whole, the wall structure 37 has parts extending in the longitudinal and transverse direction of the substrate to intersect each other in the form of a grid within the square frame of the structure.

An opening 36 is provided on a predetermined side of each frame formed by the wall structure 37 to allow the liquid crystal 3 to flow. The openings 36 are periodically and regularly disposed. The wall structure 37 has reflectance reducing portions 34 which are formed at the openings 36 to reduce the reflectance of the liquid crystal 3 at the openings 36. As will be described in detail later, since the distance (hereinafter referred to as “gap”) from flat parts 34a of the reflectance reducing portion 34 to the top substrate 7 is smaller than the cell gap of the element in the pixel regions P, the reflectance of the liquid crystal at the openings can be kept small. Thus, the liquid crystal display element 1 can be provided with high contrast.

The wall structure 37 is formed from a material having adhesive properties. The wall structure 37 is bonded to both of the top substrate 7 and the bottom substrate 9 except in the regions of the openings 36. As will be described later, the wall structure 37 is formed on either substrate by patterning a photo resist using a photolithographic process, for example. The reflectance reducing portions 34 are formed integrally with the wall structure 37.

A seal material 21 is provided at the periphery of the element to surround the wall structure 37 as a whole. The seal material 21 is formed at a printing step using a heat-curing or UV-curing adhesive. The seal material 21 is disposed at the periphery of the element between the top substrate 7 and the bottom substrate 9 to surround the plurality of pixel regions P and the wall structure 37. The wall structure 37 may be used in combination with spherical spacers or columnar spacers according to the related art in order to obtain a predetermined cell gap.

The seal material 21 has an opening on one side of the top substrate 7 and the bottom substrate 9, the opening serving as a liquid crystal injection port 38 for injecting the liquid crystal using the dipping method. Although not shown, the liquid crystal injection port 38 is sealed with an enclosing material after the liquid crystal is injected. All pixel regions P are connected to the injection port 38 through the respective openings 36. The liquid crystal 3 enclosed by the seal material 21 and the enclosing material fills the entire space inside the element surround by the seal material 21.

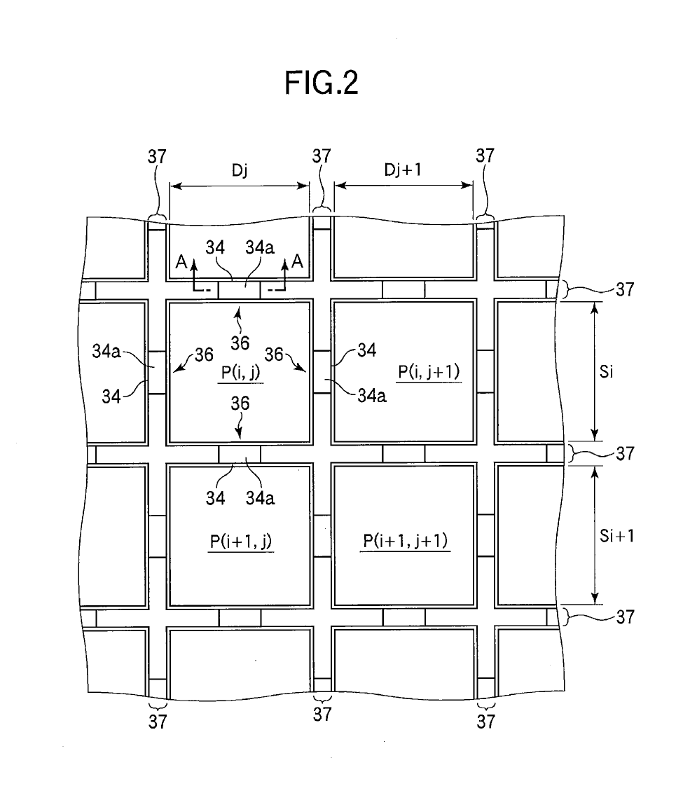

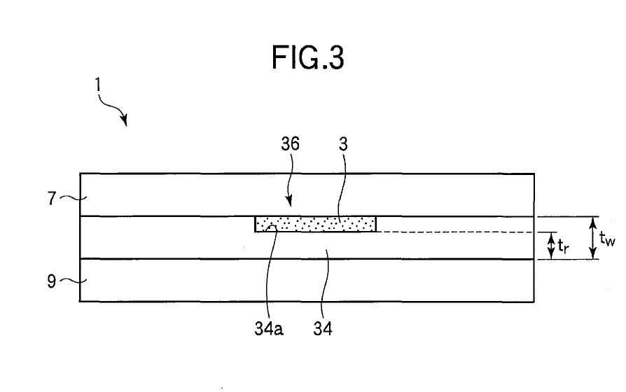

FIG. 2 is a view of the liquid crystal display element 1 taken in the normal direction of the substrate surfaces. FIG. 3 is a sectional view taken along the line A-A in FIG. 2. Although FIG. 1 shows only six pixel regions P by way of example for simpler illustration, a greater number of pixel regions P are arranged in the form of a matrix, in general. FIG. 2 shows a part of an array of a great number of pixel regions P. The shapes and structures of the pixel regions P, the wall structure 37, and the openings 36 will be described in more detail with reference to FIGS. 2 and 3 in addition to FIG. 1.

A pixel region P(i,j) shown in FIG. 2 will be specifically described. When viewed in the normal direction of the substrate surfaces, the pixel region P(i,j) has a quadrilateral shape formed by a scan electrode Si and a data electrode Dj overlapping each other. For example, the pixel region P(i,j) of the present embodiment has a square shape. The part of the wall structure 37 associated with the pixel region P(i,j) has a frame-like structure having a square shape extending along each of the four sides of the shape of the pixel. The wall structure 37 is formed with a width which is equal to or smaller than the gap between each pair of data electrodes D adjoining each other on the top substrate 7 and which is equal to or smaller than each pair of scan electrodes S adjoining each other on the bottom substrate 9. Thus, the wall structure 37 is disposed such that it does not overlap the pixel region P(i,j).

The openings 36 formed in parts of the frame-shaped wall structure 37 serve as liquid crystal communication ports for filling all pixel regions P with the liquid crystal when the liquid crystal is injected using the dipping method at a panel fabrication step. An opening 36 is formed on each side of frame formed by the wall structure 37 such that the openings on each pair of opposite sides of the frame face each other. The openings 36 are formed substantially in the middle of the respective sides of the frame.

As shown in FIG. 3, a reflectance reducing portion 34 formed at an opening 36 is in the form of a wall having a height tr which is smaller than a height tw of the wall structure 37. The reflectance reducing portion 34 has a flat part 34a formed on a side thereof facing the top substrate 7. The height tr of the reflectance reducing portion 34 is smaller than the height tw of the wall structure 37. Therefore, an opening can be left between the substrates 7 and 9 after the substrates are combined to allow the liquid crystal 3 to flow through the opening 36.

The wall structure 37 has the same configuration in parts thereof surrounding other pixel regions P(i−1,j), P(i+1,j), and P(i+2,j) on the same column to which the pixel P(i,j) belongs. That is, those regions have openings 36 formed in the same positions as described above. Therefore, the openings 36 of the pixel regions in the same column, i.e., the j-th column are aligned along an imaginary line on which the wall structure 37 extends. Other columns such as the (j+1)-th column adjacent to the j-th column have the same configuration.

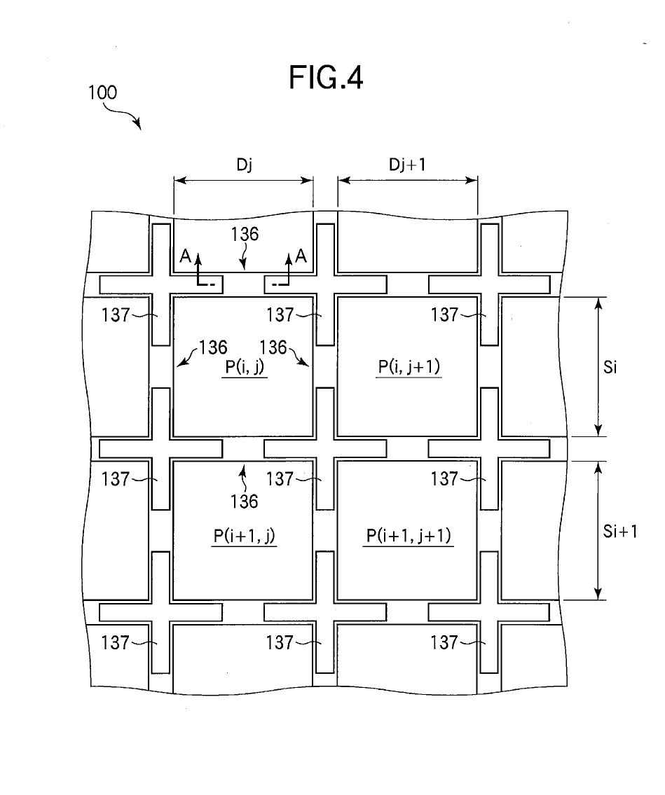

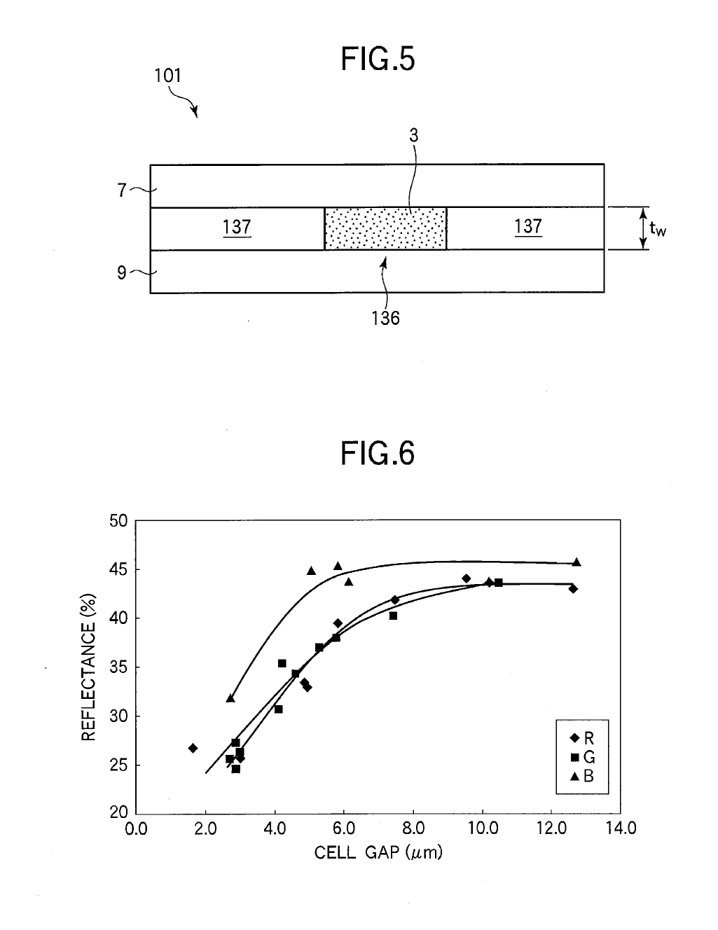

Advantages of the liquid crystal display element 1 of the present embodiment will now be described with reference to FIGS. 3 to 6. FIG. 4 is a view of a liquid crystal display element 100 according to the related art taken in the normal direction of substrate surfaces thereof. FIG. 5 is a sectional view of the element taken along the line A-A in FIG. 4. Features identical between the element shown in FIGS. 4 and 5 and the liquid crystal display element 1 of the present embodiment are indicated by like reference numerals will not be described below.

Wall structures 137 of the liquid crystal display element 100 according to the related art provided in four adjoining pixel regions P(i,j), P(i,j+1), P(i+1,j), and P(i+1,j+1) are cross-shaped as shown in FIG. 4. Wall structures 137 are disposed in each of the gaps between the four adjoining pixel regions P. Referring to the pixel region P(i,j), a wall structure 137 is disposed at each corner of the pixel so as to extend along the pixel outline. The wall structures 137 are formed with a width which is equal to or smaller than the gap between each pair of adjoining data electrodes D on a top substrate 7 and which is equal to or smaller than the gap between each pair of adjoin scan electrodes S on a bottom substrate 9. Thus, the wall structures 137 are disposed such that they do not overlap the pixel region P(i,j).

The length of the parts of the wall structures 137 extending along each side of the pixel region P(i,j) is smaller than the length of one side of the pixel region P(i,j). Therefore, no wall structure 137 is formed substantially in the middle of each side of the pixel region P(i,j) to provide an opening 136 in that area. The openings 136 serve as a liquid crystal communication port for filling all pixel regions P with a liquid crystal 3 when the liquid crystal is injected using the dipping method at a panel fabrication step.

The liquid crystal 3 flows between adjoining pixels through the openings 136 when the liquid crystal is injected using the dipping method. Therefore, when the liquid crystal injection completed using the dipping method, not only the entire pixel regions P but also the openings 136 are filled with the liquid crystal 3 as shown in FIG. 5. The cell gap of the liquid crystal display element 100 at the openings 136 is substantially equal to a height tw of the wall structures 137.

As shown in FIG. 3, the openings 36 of the liquid crystal display element 1 of the present embodiment are filled with the liquid crystal 3 when the liquid crystal injection is completed using the dipping method, just as in the liquid crystal display element 100 according to the related art. Since the liquid crystal display element 1 has the reflectance reducing portions 34 at the openings 36, the gaps provided by the openings 36 are smaller than the height tw of the wall structure 37.

The liquid crystal 3 enclosed in a pixel region P enters a planar state in which the liquid crystal reflects light of a predetermined color or a focal conic state in which the liquid crystal transmits light depending on a difference between a potential applied to the scan electrode S and a potential applied to the data electrode D. However, the openings 36 or 136 are disposed outside a pixel region P, and neither electrode S nor electrode D is formed in the regions of the openings. Therefore, no voltage is applied to the liquid crystal 3 enclosed in the openings 36 or 136. In general, when the liquid crystal 3 has moved, the liquid crystal enters the planar state in which it has a high reflectance. Therefore, even when the liquid crystal 3 in all pixel regions P is put in the focal conic state to display black on the liquid crystal display element 1 or 100, light is reflected at the openings 36 or 136 because the liquid crystal 3 is in the planar state in those regions. As a result, the liquid crystal display elements 1 and 100 undergo a reduction in contrast.

It is known that the reflectance of a cholesteric liquid crystal depends on a cell gap associated therewith. FIG. 6 is a graph showing a relationship between cell gaps and reflectances of a cholesteric liquid crystal. Cell gaps are shown along the horizontal axis (in microns), and reflectances are shown along the vertical axis (in percents). In the figure, the curve plotted based on the rhombic symbols represents reflectance characteristics of red (R) light. The curve plotted based on the square symbols represents reflectance characteristics of green (G) light. The curve plotted based on the triangular symbols represents reflectance characteristics of blue (B) light.

As shown in FIG. 6, the reflectance of any of red, green, and blue light rays is greater, the greater the cell gap. The reflectance becomes substantially constant when the cell gap exceeds a predetermined value. The reflectance of red and green light rays stays at a constant value of about 43% when the cell gap is greater than about 8.0 μm. The reflectance of blue light stays at a constant value of about 46% when the cell gap is greater than about 6.0 μm.

The cell gap of the liquid crystal display element 1 in this embodiment at the openings 36 is smaller than the cell gap of the liquid crystal display element 100 according to the related art at the openings 136 because the element 1 has the reflectance reducing portions 34. Therefore, reflectances observed at the openings 36 are lower than those observed at the openings 136. As a result, the liquid crystal display element 1 has lower reflectances and therefore higher contrast when displaying black, compared to the element according to the related art.

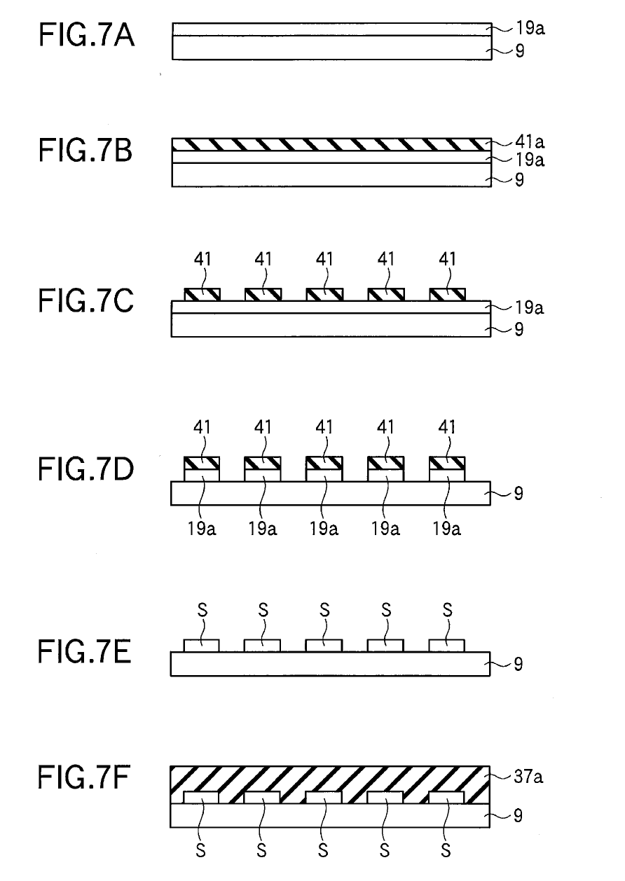

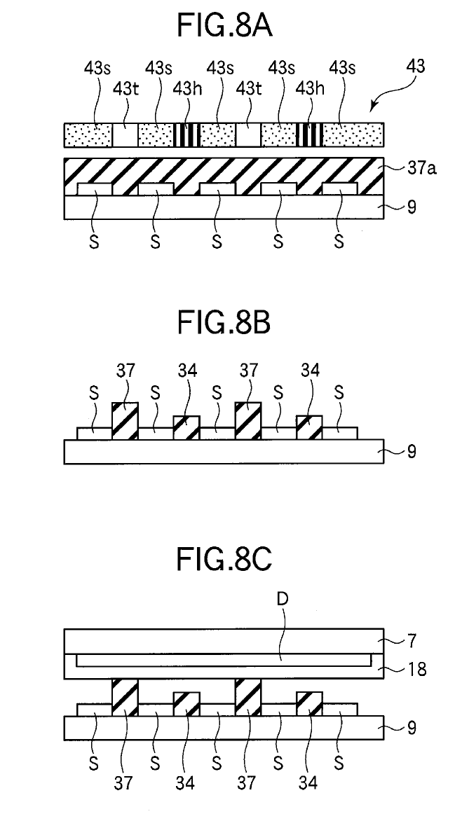

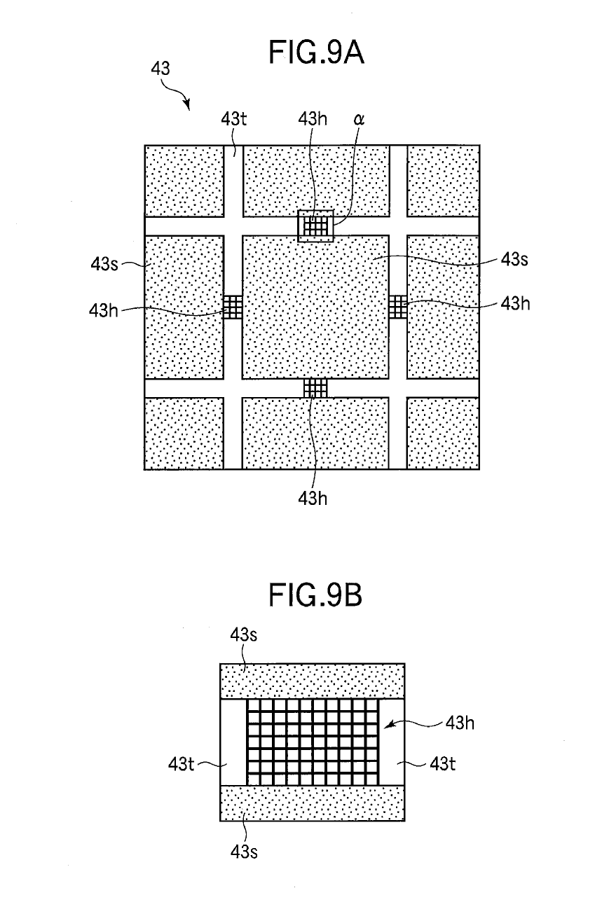

A method of manufacturing the display element according to the present embodiment will now be described with reference to FIGS. 7A to 9B. FIGS. 7A to 8C are sectional views of the liquid crystal display element 1 of the present embodiment schematically showing steps for manufacturing the element. FIGS. 9A and 9B show major parts of a photo-mask used for forming the wall structure 37.

First, as shown in FIG. 7A, a transparent conductive film 19a is formed through the vapor deposition technique on an entire surface of a bottom substrate 9 made of, for example, polycarbonate. Materials used to form the transparent conductive film 19a include, for example, an IZO (indium zinc oxide). Next, as shown in FIG. 7B, a resist is applied to the entire surface of the transparent conductive film 19a to form a resist layer 41a. Next, as shown in FIG. 7C, the resist layer 41a is patterned using a mask (not shown) having a pattern to form scan electrodes S drawn thereon, whereby a resist pattern 41 is formed.

Next, as shown in FIG. 7D, the transparent conductive film 19a is exposed and etched using the resist pattern 41 as a mask. Thus, the transparent conductive film 19a exposed at gaps of the resist pattern 41 is removed, whereby parts of the transparent conductive film 19a located under the resist pattern 41 are left on the bottom substrate 9. Next, as shown in FIG. 7E, the resist pattern 41 is removed. Thus, scan electrodes S are formed on the bottom substrate 9.

Next, as shown in FIG. 7F, a negative photo-resist is applied to the entire surface of the bottom substrate 9 to form a resist layer 37a. Pre-baking of the resist layer 37a is then performed as occasion demands. Next, as shown in FIG. 8A, the resist layer 37a is exposed using a photo-mask 43 having a pattern to form a wall structure drawn thereon.

The photo-mask 43 will now be described with reference to FIGS. 9A and 9B. FIG. 9A is a plan view of major parts of the photo-mask 43. FIG. 9B is an enlarged view of the region a shown in FIG. 9A. As shown in FIG. 9A, the photo-mask 43 for forming the wall structure 37 (see FIG. 2) includes two types of films formed on a substrate, i.e., semi-transmissive films 43h which transmit incident light such as ultraviolet light while attenuating the intensity of the light and light-blocking films 43s which serve as shields against incident light. The photo-mask 43 has a transmissive region 43t where neither semi-transmissive film 43h nor light-blocking film 43s is formed and which therefore transmits light at a predetermined optical transmittance. The semi-transmissive films 43h and the light-blocking films 43s are patterned on the substrate such that the light-blocking films 43s are disposed in regions corresponding to the pixel regions P (see FIG. 2); the transmissive regions 43t are disposed in areas corresponding to the wall structure 37; and the semi-transmissive films 43h are disposed in regions corresponding to the reflectance reducing portions 34 (see FIG. 2).

As shown in FIG. 9B, the semi-transmissive films 43h are formed in a grid pattern to transmit incident light with the intensity of the light reduced to 56%. Openings of the semi-transmissive films 43h are formed such that they are distributed in a substantially uniform density. The photo-mask 43 is a gray tone mask because it includes the transmissive region 43t which has a light transmitting width equal to or beyond the resolution of the resist layer 37a and the semi-transmissive films 43h which have a light transmitting width below the resolution of the resist layer 37a. The height tr of the reflectance reducing portions 34 can be adjusted depending on the aperture ratio of the semi-transmissive films 43h. A greater quantity of light is transmitted by the films, the greater the aperture ratio. Therefore, when a negative photo-resist is used, the height tr of the reflectance reducing portions 34 is greater, the greater the aperture ratio of the semi-transmissive films 43h. The height tr is smaller, the smaller the aperture ratio.

Referring to FIG. 8A again, when the resist layer 37a is exposed using the photo-mask 43, the region of the resist layer 37a associated with the transmissive region 43t of the photo-mask 43 is substantially completely exposed because it is exposed in an exposure amount equal to or greater than a required exposure amount. The regions of the resist layer 37a associated with the semi-transmissive films 43h are not completely exposed because they are exposed in an exposure amount smaller than the required exposure amount. The regions of the resist layer 37a associated with the light-blocking films 43s are substantially unexposed. When the resist layer 37a thus exposed is developed, as shown in FIG. 8B, the resist layer 37a is completely removed in the regions associated with the light-blocking films 43s and left in the region associated with the transmissive region 43t to obtain a resist pattern which is smaller in thickness in the regions thereof associated with the semi-transmissive films 43h than in the region thereof associated with the transmissive region 43t. Thus, there is provided a wall structure 37 which has reflectance reducing portions 34 at openings 36 thereof.

The use of the photo-mask 43 allows the reflectance reducing portions 34 to be formed integrally and contiguously with the wall structure 37 at the same time when the structure is formed. The semi-transmissive films 43h of the photo-mask 43 are formed with openings distributed in a substantially uniform density, top surfaces of the reflection reducing portions 34 are substantially flatly formed.

Next, data electrodes D are formed on the top substrate 7 using a fabrication method similar to that shown in FIGS. 7A to 7E, although not shown. Next, an insulation film 18 is formed throughout the top substrate 7 to cover the data electrodes D (see FIG. 8C). Next, a seal material 21 (see FIG. 1) is applied, for example, to the periphery of the bottom substrate 9. The seal material 21 is provided to leave an injection port 38 to be used for liquid crystal injection in a part of one end of the bottom substrate 9 (see FIG. 1). For example, spacers are then dispersed on the bottom substrate 9.

Next, as shown in FIG. 8C, the substrates 7 and 9 are combined such that the scan electrodes S and the data electrodes D face each other in an intersecting relationship so as to allow passive driving. Next, the seal material 21 and the wall structure 37 are cured by pressing and heating them to bond the substrate 7 and 9 to each other. Thus, a vacant cell is formed.

Then, the interior and the exterior of the vacant cell are put in the vacuum state, and the end of the vacant cell having the injection port 38 is immersed in a cholesteric liquid crystal. The exterior of the cell is then exposed to the atmosphere to inject the liquid crystal into the vacant cell, and the injection port 38 is thereafter sealed with an enclosing material. Thus, a liquid crystal display panel is completed. Driving circuits such as a scan electrode driving circuit and a data electrode driving circuit are thereafter connected to the liquid crystal display panel to complete a liquid crystal display element 1.

The liquid crystal display element 1 will now be more specifically described by showing examples in the above-described embodiment along with comparative examples.

### Example 1

A liquid crystal display panel of the present example is fabricated using the above-described manufacturing method, and steps for fabricating the panel will not be described. Substrates made of polycarbonate having a thickness of 100 μm are used as a top substrate 7 and a bottom substrate 9. Transparent conductive films made of an IZO are deposited on surfaces of the substrates and patterned into predetermined shapes to form scan electrodes S and data electrodes D. A wall structure 37 is formed on the bottom substrate 9 using a positive photo-resist. The wall structure 37 is formed like a grid pattern surrounding pixel regions P as shown in FIG. 2.

An opening 36 is provided substantially in the middle of each side of each pixel region P. A reflectance reducing portion 34 is formed at each opening 36, the portion having a height smaller than an average height of the wall structure 37. Since the height of the reflectance reducing portion 34 is smaller than the average height of the wall structure 37, a flat part 34a constituting a top surface of each reflectance reducing portion 34 does not contact the top substrate 7 when the top substrate 7 and the bottom substrate 9 are combined.

A photo-mask for forming the wall structure 37 has a light-blocking film and transmissive regions formed in positions which are the reverse of the positions of like features on the photo-mask 43 shown in FIGS. 9A and 9B. Specifically, the photo-mask used has a light blocking film formed in the region where the wall structure 37 is to be disposed and transmissive regions provided in areas where the pixel regions P are to be disposed. In order to form the wall structure 37 having reflectance reducing portions 34, the photo-mask includes light-blocking portions, which are semi-transmissive films having a predetermined aperture ratio (for example, 56%), in regions corresponding to the positions where the reflectance reducing portions 34 are to be formed.

An opening 36 is formed on each side of each pixel region P. The openings 36 have an opening width designed to be 14 μm where the pixel pitch is 220 μm. The term “opening width” means the length of an opening 36 in the extending direction of the side of the pixel region P on which the opening is provided. The wall structure 37 is formed such that it has a wall width of 15 μm, a wall height tw (see FIG. 3) of 4.2 μm, and a height tr of 3.5 μm at the reflectance reducing portions 34 thereof. An insulation film 18 is formed on the top substrate. Plastic spacers made of divinyl benzene are dispersed between the top substrate 7 and the bottom substrate 9 to keep a predetermined cell gap between them. A cholesteric liquid crystal adjusted to reflect green light is enclosed between the top substrate 7 and the bottom substrate 9.

The reflectance of the liquid crystal display panel was evaluated immediately after injecting the liquid crystal using a reflectance measuring apparatus which was set to receive reflected light from the liquid crystal display panel in front of the panel where light entered the liquid crystal display panel at an angle of 30°. The reflectance of the liquid crystal display panel was measured with the liquid crystal set in the planar and focal conic states by applying predetermined voltages between the top substrate 7 and the bottom substrate 9. The reflectance was 25% and 1.1% in the planar state and the focal conic state, respectively. Therefore, the liquid crystal display panel of the present example has a contrast ratio of 22.7 (=25%/1.1%). The reflected wavelength was 535 nm in both of the planar and focal conic states.

### Comparative Example 1

A liquid crystal display panel described here as a comparative example has a structure similar to that of the liquid crystal display panel provided in the liquid crystal display element 100 shown in FIGS. 4 and 5. The liquid crystal display panel of this comparative example was fabricated using materials and a manufacturing method similar to those used in Example 1. In this comparative example, wall structures were formed using a photo-mask which had transmissive regions formed in areas associated with openings of the wall structures to prevent a resist from remaining at the openings.

The reflectance of the liquid crystal display panel of this comparative example was evaluated using a method similar to that used in Example 1. The reflectance was 25% and 1.9% in the planar and focal conic states, respectively, where the reflectance of a standard white plate was used as a reference (100%). Therefore, the liquid crystal display panel of this comparative example had a contrast ratio of 13.2 (=25%/1.9%). Thus, the liquid crystal display panel of Example 1 had a contrast ratio higher than that of the liquid crystal display panel of the comparative example.

### Example 2

A liquid crystal display panel of this example is similar to Example 1 except that a wall structure 37 is formed using a negative resist. Semi-transmissive films provided on the photo-resist are formed to have an aperture ratio of 44% in order to provide reflectance reducing portions 34 of the present example with the same height as in Example 1.

The reflectance of the liquid crystal display panel of this example was evaluated using a method similar to that used in Example 1. The reflectance was 30% and 2.1% in the planar and focal conic states, respectively. Therefore, the liquid crystal display panel of this example had a contrast ratio of 14.2 (=30%/2.1%).

### Comparative Example 2

A liquid crystal display panel described here as a comparative example is similar in configuration to Comparative Example 1 except that a wall structure is formed using a negative resist. In the comparative example, a photo-mask formed with light-blocking films in regions corresponding to openings is used in order to prevent a resist from remaining at the openings when the wall structure is formed.

The reflectance of the liquid crystal display panel of this comparative example was evaluated using a method similar to that used in Example 1. The reflectance was 30% and 2.8% in the planar and focal conic states, respectively, where the reflectance of a standard white plate was used as a reference (100%). Therefore, the liquid crystal display panel of this comparative example had a contrast ratio of 10.7 (=30%/2.8%). Thus, the liquid crystal display panel of Example 2 had a contrast ratio higher than that of the liquid crystal display panel of this comparative example.

As described above, according to a display element of the embodiment of the invention, a liquid crystal display element 1 includes a wall structure 37 which is continuously formed in the form of a grid surrounding the peripheries of pixel regions P. Some parts of the wall structure 37 are bonded to a top substrate 7 and a bottom substrate 9 to maintain the cell gap of the liquid crystal display element 1. The wall structure 37 includes openings 36 for allowing the liquid crystal 3 to flow in parts other than the above-mentioned parts. Reflectance reducing portions 34 are provided at the openings 36. The reflectance reducing portions 34 are formed with a height smaller than the height of the bonded parts such that they will not contact either of the top substrate 7 and the bottom substrate 9. In the liquid crystal display element 1, the openings 36 provide gaps smaller than the cell gap in the pixel regions P while providing channels for the liquid crystal 3. The liquid crystal display element 1 can be provided with improved contrast because the reflectance of the element can be reduced at the openings 36. Thus, the liquid crystal display element 1 can display images satisfactorily.

According to the method of manufacturing a display element according to the embodiment of the invention, since the openings 36 accompanied by the reflectance reducing portions 34 can be formed simultaneously and integrally with the wall structure 37, the liquid crystal display element 1 can be manufactured by manufacturing steps and man-hours similar to those required for the liquid crystal display element 100 according to the related art.

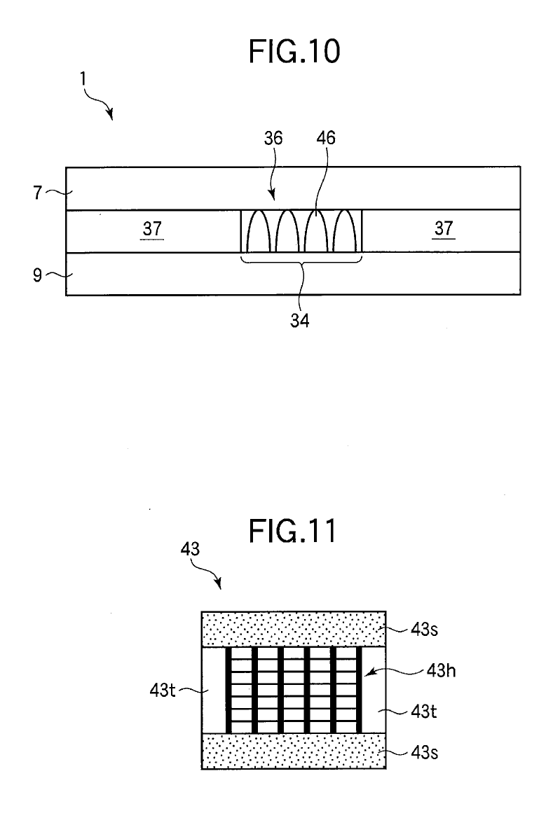

A display element and a method of manufacturing the element according to a first modification of the embodiment of the invention will now be described with reference to FIGS. 10 and 11. A liquid crystal display element 1 according to the present modification has a structure similar to that of the liquid crystal display element 1 shown in FIGS. 2 and 3 except for reflectance reducing portions 34. FIG. 10 is a sectional view of the liquid crystal display element 1 according to the present modification showing the neighborhood of an opening 36. As shown in FIG. 10, a reflectance reducing portion 34 provided at an opening 36 of the liquid crystal display element 1 according to the present modification includes a plurality of protrusions 46 formed to protrude from a bottom substrate 9. The protrusions 46 are formed with substantially the same height as an average height of a wall structure 37. The protrusions 46 are in contact with a top substrate 7. The protrusions 46 may be formed with a height smaller than the average height of the wall structure 37 such that they are not in contact with the top substrate 7.

The plurality of protrusions 46 are disposed at predetermined intervals. Therefore, a gap between each pair of adjoining protrusions 46 serves as a channel for a liquid crystal 3. Therefore, in the liquid crystal display element 1 of the present modification, the liquid crystal 3 is allowed to flow even though the protrusions are provided at the openings 36.

The protrusions 46 have the effect of disturbing the alignment of liquid crystal molecules, i.e., the helical structure of liquid crystal molecules. Thus, the cholesteric liquid crystal filling the openings 36 enters a homeotropic state in which the liquid crystal transmits incident light. Thus, the element has a low reflectance at the openings 36. As a result, the liquid crystal display element 1 has high contrast which provides the same advantages as those of the liquid crystal display element 1 shown in FIGS. 2 and 3.

A method of manufacturing a display element according to this modification will now be described with reference to FIG. 11. The method of manufacturing a display element according to this modification is similar to the method shown in FIGS. 7A to 8C except for the structure of a photo-mask for forming a wall structure 37. FIG. 11 is an enlarged plan view of a semi-transmissive film 43h provided on a photo-mask 43 used for manufacturing a liquid crystal display element 1 according to the present modification. As shown in FIG. 11, the photo-mask 43 includes semi-transmissive films 43h formed in a grid pattern to transmit incident light with its intensity reduced to about 56%. The semi-transmissive films 43h are formed in association with positions where reflectance reducing portions 34 are to be formed.

The semi-transmissive films 43h have the same transmittance as the transmittance of the semi-transmissive films 43h shown in FIG. 9B, but openings in the films have significant density distributions. Therefore, the photo-mask 43 allows a resist layer associated with the semi-transmissive films 43h to be locally exposed in an exposure amount equal to or greater than a required exposure amount. As a result, the parts of the resist layer exposed in the exposure amount equal to or greater than the required exposure amount remain at the openings 36 to become the protrusions 46.

The liquid crystal display element 1 of the present modification can be manufactured by a manufacturing method similar to that used for the liquid crystal display element 1 shown in FIG. 2 using a pattern in which the aperture ratio of the semi-transmissive films 43h spatially varies.

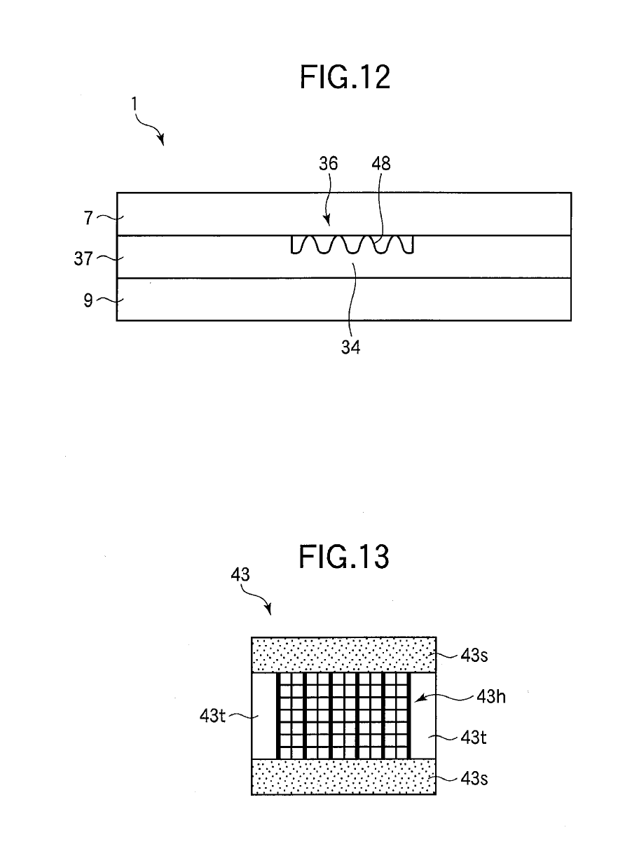

A display element and a method of manufacturing the element according to a second modification of the above-described embodiment will now be described with reference to FIGS. 12 and 13. A liquid crystal display element 1 according to the present modification has a structure similar to that of the liquid crystal display element 1 shown in FIGS. 2 and 3 except for the structure of reflectance reducing portions 34. FIG. 12 is a sectional view of the liquid crystal display element 1 according to the present modification showing the neighborhood of an opening 36. As shown in FIG. 12, a reflectance reducing portion 34 provided at an opening 36 of the liquid crystal display element 1 according to the present modification is in the form of a wall having a concave/convex part 48 formed on a surface thereof facing a top substrate 7. The concaves of the concave/convex part 48 are formed with a height smaller than an average height of the wall structure 37. The convexes of the concave/convex part 48 are formed with a height which is substantially the same as the average height of the wall structure 37, and the convexes are therefore in contact with the top substrate 7. The convexes of the concave/convex part 48 may alternatively be formed with a height smaller than the average height of the wall structure 37 such that they will not contact the top substrate 7.

The concaves of the concave/convex part 48 are lower than the height of the wall structure 37. Therefore, they form gaps between the reflectance reducing portion 34 and the top substrate 7, the gaps serving as channels for a liquid crystal 3. As a result, in the liquid crystal display element 1 of the present modification, the liquid crystal is allowed to flow even though the concave/convex parts 48 are provided at the reflectance reducing portion 34.

The concave/convex parts 48 have the effect of disturbing the alignment of liquid crystal molecules, i.e., the helical structure of liquid crystal molecules, just like the protrusions 46 in the above-described first modification. Thus, the cholesteric liquid crystal filling the openings 36 enters a homeotropic state in which the liquid crystal transmits incident light. Thus, the element has a low reflectance at the openings 36. Further, with the reflectance reducing portion 34, the gaps at the openings 36 are smaller than the cell gap in pixel regions P. Therefore, the liquid crystal display element 1 of the present modification can obtain the same effect as in the liquid crystal display element 1 shown in FIG. 2 to reduce the reflectance at the openings 36. As a result, the liquid crystal display element 1 of the present modification has high contrast which provides the same advantages as those of the liquid crystal display element 1 shown in FIG. 2.

A method of manufacturing a display element according to this modification will now be described with reference to FIG. 13. The method of manufacturing a display element according to this modification is similar to the method shown in FIGS. 7A to 8C except for the structure of a photo-mask for forming a wall structure 37. FIG. 13 is an enlarged plan view of a semi-transmissive film 43h provided on a photo-mask 43 used for manufacturing a liquid crystal display element 1 according to the present modification. As shown in FIG. 13, the photo-mask 43 includes semi-transmissive films 43h formed in a grid pattern to transmit incident light with its intensity reduced to about 56%. The semi-transmissive films 43h are formed in association with positions where reflectance reducing portions 34 are to be formed.

The semi-transmissive films 43h have substantially the same transmittance as the transmittance of the semi-transmissive films 43h shown in FIG. 11. However, openings in the semi-transmissive films 43h are smaller in density distribution than openings in the semi-transmissive films 43h shown in FIG. 11. The openings of the photo-mask 43 of the present modification do not have such a size that a resist layer can be exposed in an exposure amount equal to or greater than a required exposure amount unlike the photo-mask 43 shown in FIG. 11. However, since the openings of the photo-mask 43 of the present modification have density distributions, greater exposure amounts can be locally provided, although they are still smaller than the required exposure amount. Thus, the reflectance reducing portions 34 having the concave/convex parts 48 are formed at the openings of the wall structure 37.

The liquid crystal display element 1 of the present modification can be manufactured by a manufacturing method similar to that used for the liquid crystal display element 1 shown in FIG. 2 using a pattern in which the aperture ratio of the semi-transmissive films 43h spatially varies.

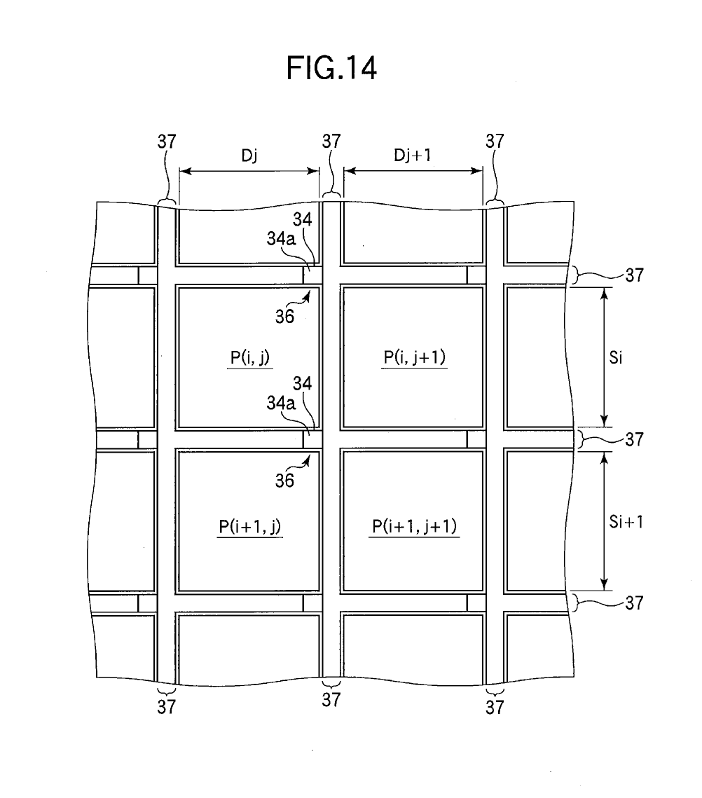

A display element according to a third modification of the above-described embodiment will now be described with reference to FIG. 14. A liquid crystal display element 1 according to the present modification has a structure similar to that of the liquid crystal display element 1 shown in FIG. 2 except for the positions where openings 36 are formed. FIG. 14 is a view of the liquid crystal display element 1 according to the present modification taken in the normal direction of substrate surfaces. Referring to a pixel region P(i,j), an opening 36 of the liquid crystal display element 1 according to the present modification is provided at one end of each of opposite sides of the wall structure 37 extending substantially parallel to a scan electrode Si, as shown in FIG. 14.

Openings 36 are formed in the same configuration and in the same positions of parts of the wall structure 37 surrounding other pixel regions P(i−1,j), P(i+1,j), and P(i+2,j) on the same column to which the pixel region P(i,j) belongs. Therefore, the openings 36 for the same column, i.e., the j-th column are aligned along an imaginary line on which the wall structure extends. Other columns such as the (j+1)-th columns have the same configuration.

A reflectance reducing portion 34 formed at each opening 36 in the present modification is formed in a wall-like shape similar to the shape of the reflectance reducing portions 34 shown in FIGS. 2 and 3. Each reflectance reducing portion 34 has a flat part 34a on a surface thereof facing a top substrate 7. The reflectance reducing portions 34 are not limited to the shape shown in FIG. 14, and the portions may obviously have the shape shown in FIG. 10 or 12.

Each pixel region P is surrounded and closed by the wall structure 37 except the side on which the openings 36 are provided. A liquid crystal 3 in the pixel region P can move out of the pixel region P through the openings 36. Therefore, in the liquid crystal display element 1 of the present modification, the mobility of the liquid crystal 3 can be maintained. Since the liquid crystal display element 1 includes the reflectance reducing portions 34 provided at the openings 36, the reflectance of the element at the openings 36 can be reduced by the same effect as that achieved in the liquid crystal display element 1 shown in FIG. 2. Thus, high contrast can be achieved, and the liquid crystal display element 1 of the present modification can obtain advantages similar to those of the liquid crystal display element 1 shown in FIG. 2.

The display element of the present modification can be manufactured using a manufacturing method similar to that used for the liquid crystal display element 1 shown in FIG. 2 except for the positions in which the semi-transmissive films 43h are formed.

### Example

An example of a liquid crystal display element 1 of the third modification will now be described. A liquid crystal display element 1 having openings 36 and a wall structure 37 having structures as shown in FIG. 14 was fabricated. The liquid crystal display element 1 of the present example was fabricated using the manufacturing method shown in FIGS. 7A to 8C except for the pattern of a photo-mask for forming the wall structure 37. Substrates made of polycarbonate having a thickness of 100 μm were used as a top substrate 7 and a bottom substrate 9. Transparent conductive films made of an IZO were deposited on surfaces of the top substrate 7 and the bottom substrate 9 to form scan electrodes Si and data electrodes Dj on the substrates. A wall structure 37 was formed on either of the substrates, for example, on the bottom substrate 9 using a negative photo-resist, the structure having the function of bonding and securing the substrate 7 and 9 to each other when combining the two substrates 7 and 9. The wall structure 37 includes a pattern which extends without discontinuation in the vertical direction when a liquid crystal injection port faces upward in the vertical direction and a pattern which extends in the horizontal direction and which is formed with openings 36.

The wall structure 37 has a repeat pattern which seems like the character “C” when the structure is viewed excluding the openings 36. The wall structure 37 includes continuous walls which extend parallel to the extending direction of the data electrodes Dj and openings 36 which are located at the ends of the C-shaped features and which are defined by non-adhesive walls in no contact with, for example the top substrate 7. Reflectance reducing portions 34 are formed at the opening 36. The reflectance reducing portions 34 are formed integrally with the wall structure 37 using a photo-mask having light-blocking films which have an appropriate aperture ratio equivalent to that of the light-blocking films 43h shown in FIG. 9B and which are provided in positions corresponding to the reflectance reducing portions 34 shown in FIG. 14. A photo-mask having light-blocking films whose openings have the same aperture ratio as described above and which have density distributions may be used to form concave/convex parts on top surfaces of the reflectance reducing portions 34 or to form protrusions on the reflectance reducing portions 34.

The openings 36 are formed on two sides of a part of wall structure 37 surrounding each pixel region P. The openings 36 have an opening width designed to be 14 μm where the pixel pitch is 220 μm. The openings 36 were formed to have a wall width of 15 μm. The wall structure 37 has a wall height of 4.2 μm. The reflectance reducing portions 34 at the openings have a height of 3.5 μm.

An insulation film was formed on the top substrate 7. An opening was formed in a seal material 21 at an end of the substrates to provide an injection port for injecting a liquid crystal. The two substrates 7 and 9 were combined, and the substrates were pressed, and heated to bond them to each other. A vacant cell provided as thus described was put in a vacuum state. An end of the vacant cell was immersed in a cholesteric liquid crystal adjusted to reflect green light, and the cell was exposed to the atmosphere to inject the liquid crystal.

The reflectance of the liquid crystal display panel was evaluated immediately after injecting the liquid crystal using a method similar to the method used in Example 1 of the above-mentioned embodiment. The reflectance was 30.4% and 1.8% in the planar state and the focal conic state, respectively. Therefore, the liquid crystal display panel of the present embodiment has a contrast ratio of 16.8 (=30.4%/1.8%). The reflected wavelength was 535 nm in both of the planar and focal conic states.

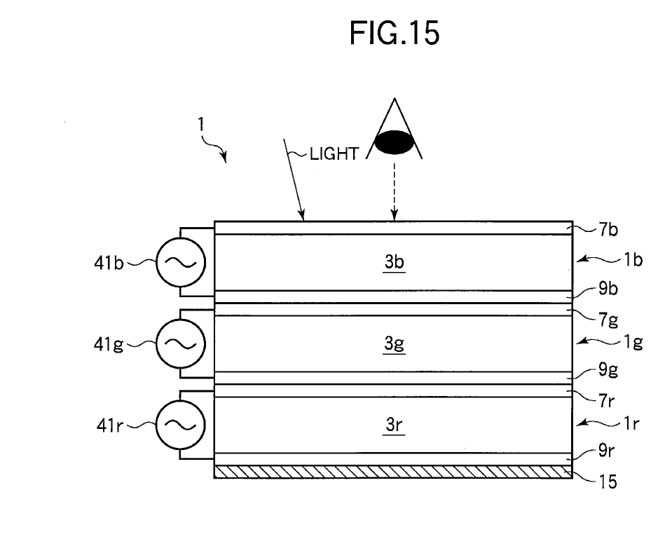

FIG. 15 schematically shows a sectional configuration of a liquid crystal display element 1 capable of full-color display utilizing cholesteric liquid crystals. The liquid crystal display element 1 includes a liquid crystal display element 1b for blue (B), a liquid crystal display element 1g for green (G), and a liquid crystal display element 1r for red (R) which are formed in the order listed from a side of the element 1 where a display surface is provided. In FIG. 15, the display surface is the side of the element where a top substrate 7b is provided, and external light (indicated by the arrow in a solid line) impinges on the display surface from above the top substrate 7b. An eye of a viewer and the viewing angle of the viewer (indicated by the arrow in a broken line) are schematically shown above the top substrate 7b.

The B liquid crystal display element 1b includes a liquid crystal layer 3b for blue (B) formed between a pair of substrates, i.e., a top substrate 7b and a bottom substrate 9b and a pulse voltage source 41b for applying a predetermined pulse voltage to the B liquid crystal layer 3b. The B liquid crystal layer 3b includes a cholesteric liquid crystal reflecting blue light in the planar state. The G liquid crystal display element 1g includes a liquid crystal layer 3g for green (G) formed between a pair of substrates, i.e., a top substrate 7g and a bottom substrate 9g and a pulse voltage source 41g for applying a predetermined pulse voltage to the G liquid crystal layer 3g. The G liquid crystal layer 3g includes a cholesteric liquid crystal reflecting green light in the planar state. The R liquid crystal display element 1r includes a liquid crystal layer 3r for red (R) formed between a pair of substrates, i.e., a top substrate 7r and a bottom substrate 9r and a pulse voltage source 41r for applying a predetermined pulse voltage to the R liquid crystal layer 3r. The R liquid crystal layer 3r includes a cholesteric liquid crystal reflecting red light in the planar state. A visible light absorbing layer 15 is disposed on a bottom surface of the bottom substrate 9r of the R liquid crystal display element 1r.

A cholesteric liquid crystal tends to necessitate a higher driving voltage, the shorter the wavelength of the light reflected by the same. A cell gap d necessitates a lower driving voltage, the smaller the cell gap. Therefore, driving voltages for the liquid crystal layers 3b, 3g, and 3r can be made equal to each other by providing the liquid crystal layers 3b, 3g, and 3r with different cell gaps among which the cell gap for the B liquid crystal layer 3b is smallest.

The liquid crystal display element 1 has memory characteristics, and the element is therefore capable of displaying vivid full-color display without consuming electric power except when rewriting a screen.

The liquid crystal display element 1 of the present embodiment has high flexibility and high antishock properties, and it exhibits high durability against presses on the display surface. Therefore, the element can be used as a display element of electronic paper with satisfactory results. Applications of electronic paper utilizing the liquid crystal display element 1 as a display element thereof include electronic books, electronic newspapers, electronic posters, and electronic dictionaries. The liquid crystal display element 1 of the present embodiment can be used with satisfactory results as a display element of mobile apparatus which are required to have flexibility and a great storage temperature range, such apparatus including mobile terminals such as PDAs (personal digital assistants) and wrist watches. Other applications of the element include display elements of displays for paper-type computers which are anticipated to become available in future and display apparatus in various fields such as displays for decorative display of commodities at stores.

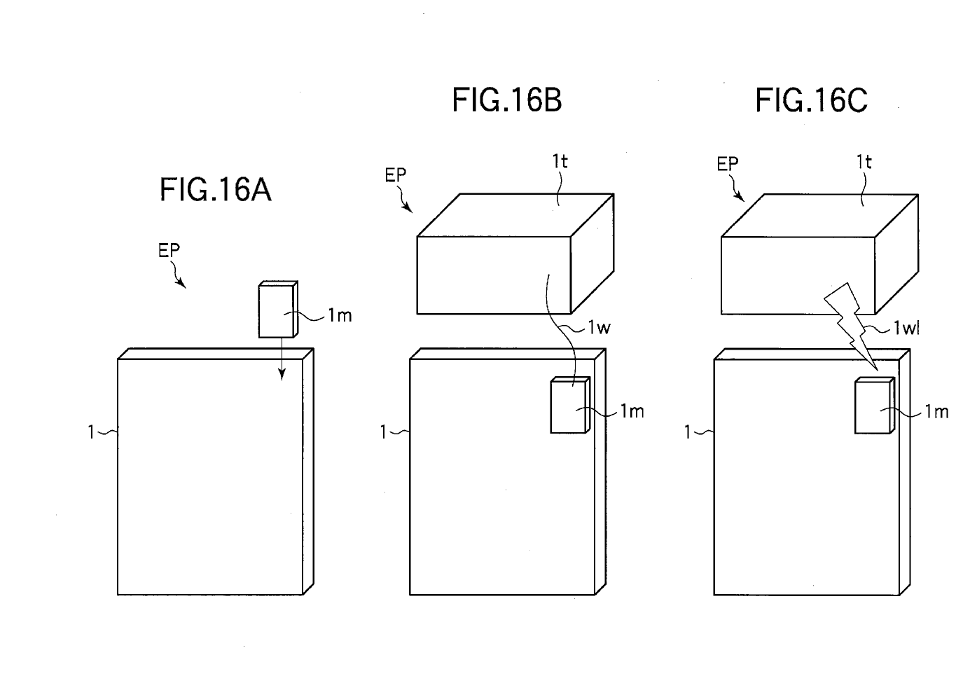

Electronic paper is completed by providing the liquid crystal display element 1 thus completed with an input/output device and a control device for exercising overall control of the element (neither of the devices is shown). FIGS. 16A to 16C show specific examples of electronic paper EP having a liquid crystal display element 1 according to the present embodiment. FIG. 16A shows electronic paper EP which is configured to use a non-volatile memory 1m having image data stored therein in advance by inserting and removing it to and from a liquid crystal display element 1 according to the embodiment. For example, image data in a personal computer or the like is stored in the non-volatile memory 1m, and an image may be displayed by inserting the memory into the electronic paper EP.

FIG. 16B shows electronic paper EP configured by incorporating a non-volatile memory 1m in a liquid crystal display element 1 according to the embodiment. For example, image data stored in a terminal it (the terminal 1t may form a part of the electronic paper EP) can be transferred by wire and stored in the non-volatile memory 1m to display an image.

FIG. 16C shows an example in which a wireless transmission/reception system (e.g., a radio LAN or Bluetooth system) is provided for a terminal it and a liquid crystal display element 1. Image data stored in the terminal it can be transferred through the wireless transmission/reception system 1wl and stored in a non-volatile memory 1m to display an image.

The invention is not limited to the above-described embodiments and may be modified in various ways.

The liquid crystal display elements 1 described above as embodiments of the invention have a single-layer structure or a three-layer structure formed by stacking B, G, and R liquid crystal display elements 1b, 1g, and 1r. However, the invention is not limited to such elements, and the invention may be applied to liquid crystal display elements having a structure formed by stacking two layers or four or more layers.

What is claimed is:

1. A display element comprising:
a pair of substrates;
a liquid crystal enclosed between the pair of substrates;
first electrodes formed on either of the pair of substrates;
second electrodes formed on the other of the pair of substrates;
a pixel region defined by disposing the substrates such that the first electrodes and the second electrodes face each other in an intersecting relationship;
a wall structure formed between the pair of substrates and outside the pixel region so as to surround the pixel region;
an opening provided in a part of the wall structure to allow the liquid crystal to flow; and
a reflectance reducing portion formed at the opening to reduce the reflectance of the liquid crystal at the opening.

2. The display element according to claim 1, wherein the reflectance reducing portion is formed integrally with the wall structure.

3. The display element according to claim. 2, wherein the reflectance reducing portion is in the form of a wall having a height smaller than the height of the wall structure.

4. The display element according to claim 3, wherein the reflectance reducing portion includes a flat part formed on a surface thereof facing either of the pair of substrates.

5. The display element according to claim 3, wherein the reflectance reducing portion includes a concave/convex part formed on a surface thereof facing either of the pair of substrates.

6. The display element according to claim 1, wherein the reflectance reducing portion includes a protrusion formed to protrude from either of the pair of substrates.

7. The display element according to claim 1, wherein the pixel region has a shape having four sides.

8. The display element according to claim 7, wherein the opening is formed substantially in the middle of the sides.

9. The display element according to claim 7, wherein the opening is formed at one end of a pair of sides opposite to each other, among the four sides.

10. The display element according to claim 1, wherein the width of the wall structure is equal to or smaller than a gap between an adjoining pair of the electrodes formed on either of the substrates.

11. The display element according to claim 1, wherein the wall structure is bonded to both of the pair of substrates.

12. The display element according to claim 1, wherein the liquid crystal has memory characteristics.

13. The display element according to claim 1, wherein the liquid crystal is a cholesteric liquid crystal.

14. A display element comprising display elements according to claim 1 formed one over another in the form of two or more layers.

15. A display element comprising display elements according to claim 1 formed one over another in the form of three layers, wherein:
one liquid crystal reflects blue light;
another liquid crystal reflects green light; and
still another liquid crystal reflects red light.

16. Electronic paper for displaying an image, comprising the display element according to claim 1.

17. Electronic terminal apparatus comprising the display element according to claim 1.

18. A method of manufacturing a display element having a liquid crystal enclosed between a pair of substrates, comprising the steps of:
forming first electrodes formed on either of the pair of substrates;
forming second electrodes formed on the other of the pair of substrates;
forming a pixel region by disposing the substrates such that the first electrodes and the second electrodes face each other in an intersecting relationship to define the pixel region;
forming a wall structure between the pair of substrates and outside the pixel region so as to surround the pixel region;
forming an opening in a part of the wall structure to allow the liquid crystal to flow; and
forming a reflectance reducing portion at the opening to reduce the reflectance of the liquid crystal at the opening.

19. The method according to claim 18, wherein the reflectance reducing portion is formed integrally and simultaneously with the wall structure.

20. The method according to claim 18, wherein the reflectance reducing portion is formed in the form of a wall having a height smaller than the height of the wall structure.
